(19) United States
(12) Patent Application Publication
(10) Pub. No.: US 2017/0222944 A1
(43) Pub. Date: Aug. 3, 2017

(54) COMPUTING RESOURCE DEPLOYMENT IN NON-MUTUALLY CONFIGURABLE ENVIRONMENTS

(71) Applicant: Microsoft Technology Licensing, LLC, Redmond, WA (US)

(72) Inventors: Raghavendra Vasanth Shantha, Redmond, WA (US); Jianyun Tao, Bellevue, WA (US); Angel Sarmento Calvo, Seattle, WA (US)

(21) Appl. No.: 15/011,268

(22) Filed: Jan. 29, 2016

(51) Int. Cl. H04L 12/911

(52) U.S. Cl. CPC H04L 47/70

(57) ABSTRACT

Computing resource deployment in one or more non-mutually configurable environments. A deployer has access to one or more manifests associated with one or more environment-specific deployments that are non-mutually configurable with other environment-specific deployments. The deployer is configured to use a set of one or more environment-independent directives and the one or more manifests to generate dynamic configuration information corresponding to the set of one or more environment-independent directives. Furthermore, a deployment compiler is configured to compile at least the generated dynamic configuration information in order to generate a set of one or more deployment instructions. The generated set of one or more deployment instructions are provided to, and structured to be interpretable by, a deployment server that is configured to assist in performing the set of one or more environment-independent directives within one or more of the non-mutually configurable environments.

### BACKGROUND

Computer systems and related technology affect many aspects of society. Indeed, the computer system's ability to process information has transformed the way we live and work. Computer systems now commonly perform a host of tasks (e.g., processing, scheduling, accounting, etc.) remotely for end users, thus providing the end users with sufficient computer processing potential for almost any task. For example, cloud computing systems can remotely perform all, or most, processing required to run an end user's website or a business' IT department rather than performing such processing on-site.

As such, more individuals and businesses alike are using cloud computing systems to fulfill their day-to-day computing needs. In some instances, end users may be able to request a cloud computing system to provide access to a certain number of virtual machines, servers, databases, etc., each one running in a particular environment and having particular software installed. While this provides great flexibility, it can also cause great complexity in the process of deploying these computing resources in a cloud computing environment, especially as it relates to IT professionals responsible for managing the ever-changing computing resource necessities of large businesses.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to deploying computing resources in one or more non-mutually configurable environments using one or more environment-independent directives. Accordingly, even if there are many different environments in which computing resources could potentially be deployed, the deployment can be described within the environment-independent directives without concern for the actual environment in which the resources will be deployed. Accordingly, the directive(s) may be reused as needed when a common set of resources is to be deployed, regardless of the environment in which that common set of resources is to be deployed.

For example, in some embodiments, a deployer has access to one or more manifests associated with one or more environment-specific deployments that are non-mutually configurable with other environment-specific deployments. The deployer uses the set of one or more environment-independent directives and the one or more manifests to generate dynamic configuration information corresponding to the set of one or more environment-independent directives. Furthermore, a deployment compiler accesses and compiles at least the generated dynamic configuration information in order to generate a set of one or more deployment instructions.

The generated set of one or more deployment instructions are provided to, and structured to be interpretable by, a deployment server that is configured to assist in performing the set of one or more environment-independent directives within one or more of the non-mutually configurable environments. In other words, the deployment server interprets the deployment instructions to thereby deploy the resources identified in the environment-independent directives into the appropriate environment corresponding to the manifest. Deployment of the same set of resources into a different environment can be accomplished using the very same environment-independent directives, by changing the manifest that is appropriate for the new environment.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 abstractly illustrates a computer system in which some embodiments described herein may be employed;

FIG. 2 illustrates a high-level computer environment for deploying computing resources using environment-independent directives separated from environment-specific data;

FIG. 3 illustrates an example deployment computing system for deploying computing resources in one or more environments;

FIG. 4 illustrates a flow chart of an example method for compiling dynamic configuration information at a deployment compiler; and

FIG. 5 illustrates a flow chart of an example method for generating dynamic configuration information to be used by a deployment compiler.

### DETAILED DESCRIPTION

At least some embodiments described herein relate to deploying computing resources in one or more non-mutually configurable environments using one or more environment-independent directives. Accordingly, even if there are many different environments in which computing resources could potentially be deployed, the deployment can be described within the environment-independent directives without concern for the actual environment in which the resources will be deployed. Accordingly, the directive(s) may be reused as needed when a common set of resources is to be deployed, regardless of the environment in which that common set of resources is to be deployed.

For example, in some embodiments, a deployer has access to one or more manifests associated with one or more environment-specific deployments that are non-mutually configurable with other environment-specific deployments. The deployer uses the set of one or more environment-independent directives and the one or more manifests to generate dynamic configuration information corresponding to the set of one or more environment-independent directives. Furthermore, a deployment compiler accesses and compiles at least the generated dynamic configuration information in order to generate a set of one or more deployment instructions.

The generated set of one or more deployment instructions are provided to, and structured to be interpretable by, a deployment server that is configured to assist in performing the set of one or more environment-independent directives within one or more of the non-mutually configurable environments. In other words, the deployment server interprets the deployment instructions to thereby deploy the resources identified in the environment-independent directives into the appropriate environment corresponding to the manifest. Deployment of the same set of resources into a different environment can be accomplished using the very same environment-independent directives, by changing the manifest that is appropriate for the new environment.

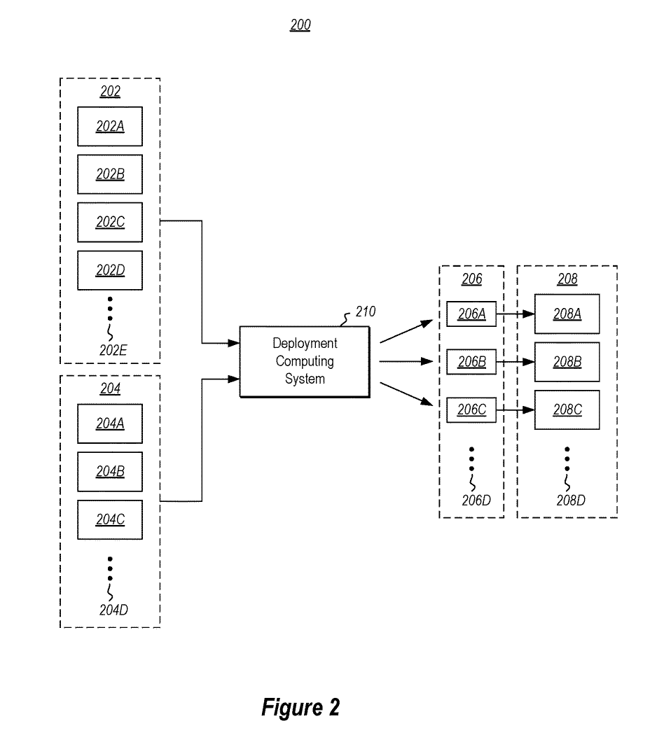

Because the principles described herein operate in the context of a computing system, a computing system will first be described as an enabling technology for the principles described herein. Thereafter, further details regarding the deployment of computing resources using environment-independent directives will be described with respect to FIGS. 2 through 5.

Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, etc.). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

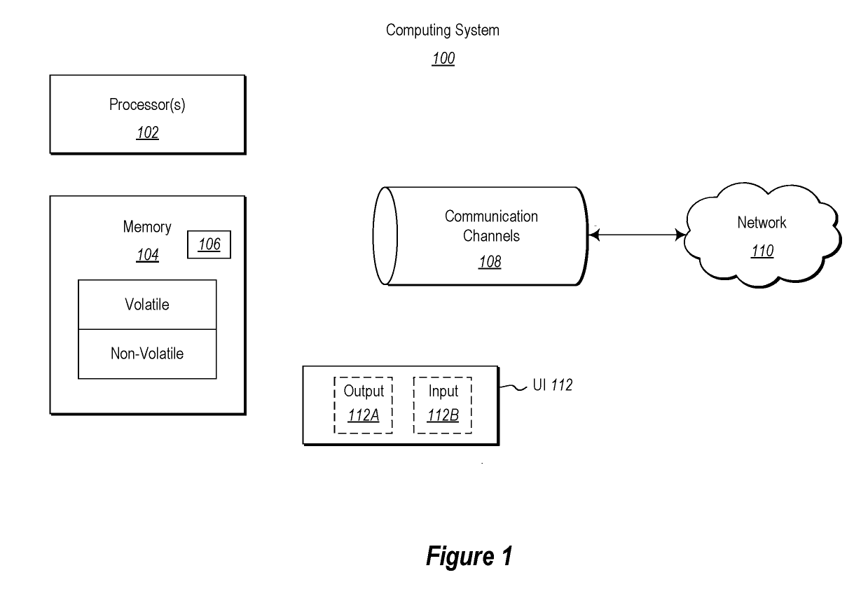

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

Each of the depicted computer systems is connected to one another over (or is part of) a network, such as, for example, a Local Area Network (“LAN”), a Wide Area Network (“WAN”), and even the Internet. Accordingly, each of the depicted computer systems as well as any other connected computer systems and their components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

The computing system 100 has thereon multiple structures often referred to as an “executable component”. For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “service”, “engine”, “module”, “controller”, “validator”, “runner”, “deployer” or the like, may also be used. As used in this description and in the case, these terms (regardless of whether the term is modified with one or more modifiers) are also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments, the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms and so forth. Examples of input mechanisms 112B might include, for instance, microphones, touchscreens, holograms, cameras, keyboards, mouse of other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media includes RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a high-level computer environment for deploying computing resources in one or more environments that can operate within computer system 100. As described herein, deployment computing system 210 uses configuration documents 202 and manifests 204 to deploy computing resource set 206 within environments 208. Each configuration document 202 contains a set of one more environment-independent directives to deploy computer resources, but the directives are expressed in a manner that the environment is not specified. Rather, each of manifests 204 corresponds to environment-specific information that assists in deploying computing resource sets within the specific environment. The principles described herein merge the directives (which are environment independent) with the appropriate manifest (which is environment specific) to thereby properly deploy the computing resource set in the environment without requiring the directives themselves to specify environmental details.

The deployment computing system 210 may deploy a wide variety of computing resources set within a wide variety of environments, and may be repeatedly used. Accordingly, the deployment computing system 210 is illustrated as receiving multiple configuration documents 202 and multiple manifests 204, which would occur in the process of several deployments actions. For instance, the deployment computing system illustrates the deployment of various computing resources 206 into various environments.

The precise number of configuration documents 202, manifests 204, computing resources 206 and environments 208 with which the deployment computing system 210 operates is not critical. However, for example purposes only, the configuration documents 202 are illustrated as including four configuration documents 202A through 202D, with the ellipses 202E symbolizing flexibility in this number. Also, for example only, manifests 204 are illustrated as including three manifests 204A through 204C. Again, the ellipses 204D symbolize that there is flexibility in the number of manifests. There may, for instance, be one manifest corresponding to each possible environment 208 in which computing resources may be deployed. As an example, in FIG. 2, the environments 208 include three environments 208A through 208C, each perhaps corresponding to respective manifests 204A through 204C. Likewise, ellipses 208D represents that the deployment described herein is not limited to a particular number of target environments.

Each of the deployment sets 206 may include one or more computing resources that are deployed into the corresponding environment 208. For instance, computing resource(s) 206A is illustrated as being deployed within the environment 208A. As an example, this might have been performed in response to configuration document 202A (that identifies the computing resource(s) 206A) in conjunction with the manifest 204A (that corresponds to the environment 208A). Furthermore, computing resource(s) 206B is illustrated as being deployed within the environment 208B. Again, for instance, this might have been performed in response to configuration document 202B (that identifies the computing resource(s) 206B) in conjunction with the manifest 204B (that corresponds to the environment 208A). Each of the configuration documents 202, manifests 204, computing resources 206, and the environments 208 will now be described in further detail.

Configuration documents 202 contain environment-independent directives to deploy one or more (and potentially multiple) of the computing resources 206. In other words, the configuration document contains instructions for what computing resources 206 are to be deployed, and at least identify the computing resource(s) for deployment. The computing resources to be deployed may comprise hardware and/or software. For example, the computing resources may include hardware in the form of servers, databases, and virtual machines, among others. Similarly, the computing resources may include software in the form of applications, operating systems, and so forth. Generally, hardware and software are both deployed within any given deployment of computing resources.

Accordingly, configuration document 202 may comprise instructions to deploy a database server, a server for a particular web application, a virtual machine with a particular operating system installed, and/or a virtual machine with a particular software application installed, among other deployment instructions. In a more specific example, the configuration document may include instructions to deploy a virtual machine with a given operating system. Thus, the configuration document may contain instructions to deploy any type of hardware and/or software that fulfills a user's needs.

Any single configuration document can deploy any number and/or types of computing resources. Notably, the configuration document includes instructions that are abstracted and independent from any particular environment in which the computing resources are to be deployed (i.e., separate from a manifest that contains specific environment data, as discussed herein). As such, the configuration document can be used repeatedly for different environments and applications when those same computing resources directed to be deployed within the particular configuration document are needed.

As briefly mentioned, computer environment 200 also includes manifests 204. Each manifest comprises data regarding the environment(s) (e.g., one of the environments 208) in which the computing resources detailed in the configuration document 202 are to be deployed. The manifest 204 further includes any technical aspects of what is required to deploy computing resources in the specified environments. In other words, the manifest includes data regarding where to deploy the resources outlined in the configuration document (i.e., in which environment), as well as how to perform the deployment in the specified environment(s).

The potential computer environments 208 in which these computing resources may be directed to be deployed within the manifest include both cloud computing environments and on-premises environments. For example, computing resources may be deployed in cloud computing environments such as MICROSOFT® AZURE™ (“AZURE”) or AMAZON® Web Services (“AWS”), among others. Similarly, computing resources may be deployed in on-premises environments such as HYPER-V® or VMWARE®, among others. That said, the principles described herein are not limited to any particular environment or environment type, nor even to environments that exist as of the time of filing of this patent application.

While not always true, the data comprising each environment-specific deployment is generally non-mutually configurable with the other environment-specific deployments. In other words, two environments are “non-mutually configurable” if the configuration information for each of the environments is at least partially different, and different in a manner that would impact how the computing resource(s) are deployed. Accordingly, each non-mutually configurable environment has dedicated instructions (often within a file called a “manifest”) regarding how to perform the deployment within the corresponding environment.

For example, one or more manifests comprising data for deploying computing resources in both AZURE and AWS must have data specific to deployment in AZURE and separate data specific to deployment in AWS. In some embodiments, instructions included in the manifest may include items such as credentials, accreditation, keys, names, and passwords necessary to perform a deployment in a specified environment 208. In other embodiments, the manifest may include information regarding how to perform computations or create storage in a specified environment 208. For instance, the manifest may include information regarding how to create a virtual hard drive (VHD).

As briefly mentioned, deployment computing system 210 obtains a configuration document 202 and a manifest 204 and then deploys computing resources 206 within environments 208. The deployed computing resources 206 correspond to the environment-independent directives of configuration document 202, while the deployed environments 208 correspond to the environment-specific data included within the manifest 204. Accordingly, the combination of the configuration document 202 and the manifest 204 may be configured to have multiple different resources deployed in multiple different environments that are each non-mutually configurable with the other environments specified.

For instance, configuration document 202 and manifest 204 may contain instructions to deploy computing resource(s) 206A within environment 208A and computing resource(s) 206B within environment 208B. In a more specific example, computing resource 206A may be a database server operating within an environment 208A that comprises AZURE and computing resource 206B may be a web application server operating within an environment 208B that comprises AWS. While FIG. 2 demonstrates four different environments 208 and four different sets of computing resources 206, ellipses 208E represent that there may be any number of environments 208 with any number of deployed computing resources 206.

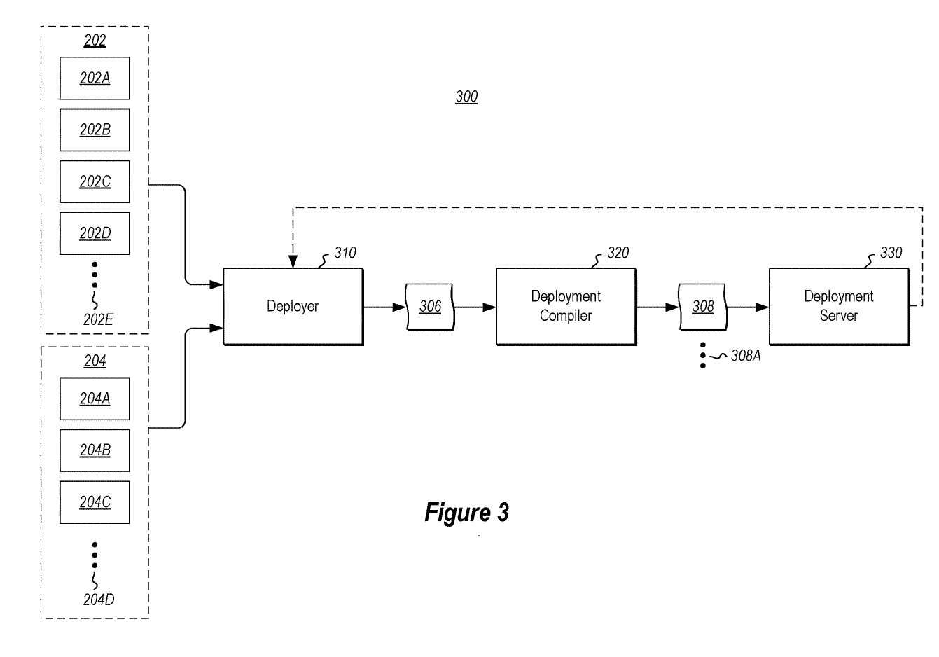

While FIG. 2 gives a high-level example of the functionality of deployment computing system 210, FIG. 3 illustrates a more specific example of the functionality and corresponding components of the deployment computing system. The environment 300 once again includes configuration document(s) 202 and manifest(s) 204, which are used by deployer 310 to generate dynamic configuration information 306. Generated dynamic configuration information 306 is then provided to, and compiled by, deployment compiler 320 in furtherance of the deployment of computing resources, as will be discussed in further detail herein.

Deployer 310 may obtain configuration document 202 and manifest 204 in any manner appropriate to the circumstances. In some embodiments, the deployer may pull or request the configuration document and manifest from any applicable source. For example, the deployer may request the configuration document and manifest from a database, a user, web services, or deployment compiler 320.

In some embodiments, deployment compiler 320 may obtain configuration document 202 and manifest 204 before deployer 310. In such circumstances, the deployment compiler may simply provide the deployer with the necessary information from the configuration document and manifest to generate dynamic configuration information 306, rather than providing the entire configuration document and manifest to the deployer. In other embodiments, the deployment compiler may provide the deployer with the entire configuration document and manifest. Alternatively, the configuration document and manifest may be sent to the deployer from any applicable source without the deployer requesting such. For example, a user may provide the configuration document and the manifest to the deployer.

In some embodiments, the deployer may generate dynamic configuration information 306 based on default settings if either or both of the configuration document and the manifest are not provided. In such cases, the default settings can provide the environment-independent directives of a configuration document or the environment-specific data of a manifest necessary to perform a deployment in at least one environment. For example, the default settings applied may be user defined, based on a previous deployment, based on artificial intelligence, and so forth.

Similarly, if particular information within the configuration document or the manifest is necessary and not provided, default settings for that missing information may be applied. Furthermore, in some embodiments, the manifest may include dynamic data and/or artificial intelligence that determine in which environments to deploy. For example, the manifest may determine where to deploy based on the cost of deployment in the environment, the complexity of deployment based on the combination of what computing resources are to be deployed and where those computing resources can be deployed, and so forth.

Dynamic configuration information 306 may include anything that is necessary for the deployment compiler to compile the dynamic configuration information, to thereby generate deployment instructions to be used by a deployment server, as described herein. For instance, the generated dynamic configuration information may comprise software installation dependencies associated with a set of one or more environment-independent directives, account subscription information associated with a user, or a pointer to created storage associated with a set of one or more environment-independent directives, among other information.

Furthermore, rather than just supplying dynamic configuration information 306 to deployment compiler 320, deployer 310 may also perform deployment and pre-deployment tasks. For instance, the deployer may perform parts or all of both infrastructure setup and software installation. For example, the deployer may ensure that all software dependencies are available locally to any machine that is to be deployed, deploy software installation dependencies described in a manifest, create a VHD, initialize storage, create one or more virtual machines, call into application program interfaces (API's), validate whether a server image exists, deploy and install roles in one or more specified environments (e.g., the role of a web server in a particular environment), or install any desired operating systems, among other tasks.

The deployer may comprise all of the business logic necessary to perform any given deployment specified in the configuration document and the manifest. Accordingly, the deployer may be configured to be extensible, allowing new functionality to continually be added to the deployer. For example, when information regarding the configuration document and/or the manifest is provided to the deployer that is not understood by the deployer, the functionality required to make use of that information may be added to the deployer.

Similarly, when the deployer is provided information regarding the configuration document and/or the manifest that the deployer does not understand, that information may simply be ignored until, or unless, the functionality necessary to understand that information is added to the deployer. As such, the deployer may comprise a software plug-in configured to function with one or more specific deployment compilers. For instance, the deployer may communicate with the deployment compiler through an API of the deployment compiler that specifies how the deployer and the deployment compiler should interact. In other embodiments, the deployer may be a standalone software application.

As referred to herein, the deployment compiler is configured to compile dynamic configuration information 306 in order to generate a set of one or more deployment instructions 308. Deployment compiler 320 may be configured to operate on one or more operating systems. Various types of deployment compilers in existence today include CHEF®, PUPPET®, and MICROSFT's Desired State Configuration (“DSC”), among others.

In some embodiments, the deployment compiler may compile configuration document 202 and manifest 204, in addition to dynamic configuration information 306, in order to generate the set of one or more deployment instructions 308. In some embodiments, the deployer may obtain the configuration document and the manifest before the deployment compiler—in such cases, the deployer may provide the document and manifest to the deployment compiler, along with providing the generated dynamic configuration information. Other embodiments may include both the deployer and the deployment compiler obtaining the configuration document and manifest separately.

The deployment compiler may generate one file of deployment instructions 308, regardless of the number of environments in which computing resources are to be deployed. Alternatively, the deployment compiler may generate a separate file of deployment instructions 308 for each environment in which computing resources are to be deployed.

Once the deployment compiler has generated the set of one or more deployment instructions 308, they are provided to, and structured to be interpretable by, deployment server 330. For example, the deployment instructions 308 may be managed object format (“MOF”) files, interpretable by a deployment server 330.

The deployment server is then configured to use the deployment instructions 308 to assist in the deployment of computing resources in one or more environments. Accordingly, once the deployment instructions are received, deployment server 330 may then carry out the deployment of computing resources specified in the configuration document within the environment(s) specified in the manifest. Alternatively, as demonstrated in FIG. 3, the deployment server may call in to the deployer in order to have the deployer carry out the deployment of computing resources within the environment(s) specified in the manifest.

The deployment server 330 may be configured to operate on one or more operating systems and comprise a standalone software application or be part of deployment compiler 320. For example, deployment server 330 may be Local Configuration Manager (“LCM”), which is part of MICROSOFT's deployment compiler, DSC.

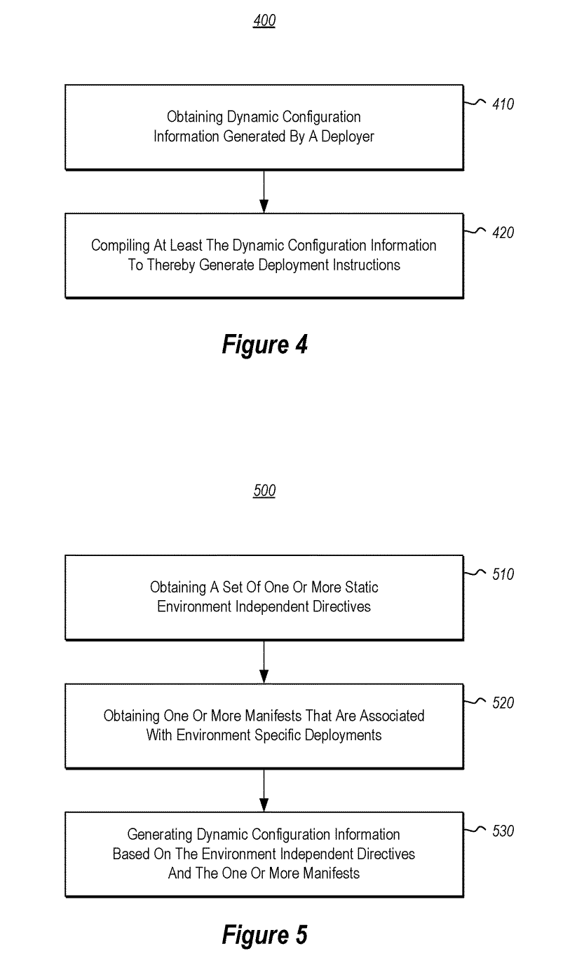

FIG. 4 illustrates a flow chart of an example method 400 of the above described deployment of computing resources from the perspective of the deployment compiler. Method 400 will be described with respect to the components of computer system 300. The method begins when deployment compiler 320 has obtained dynamic configuration information 306 that is generated by deployer 310 (act 410). As described herein, the deployer generates the dynamic configuration information based on a set of one or more environment-independent directives of configuration document 202 that identify what to deploy, as well as one or more manifests that are associated with one or more environment-specific deployments, each of which are generally non-mutually configurable with the other environment-specific deployments (i.e., the manifest describes where to deploy and how to do so in the particular environment specified).

Deployment compiler 320 then compiles at least the dynamic configuration information 306 in order to generate a set of one or more deployment instructions 308 that are structured to be interpretable by deployment server 330 (act 420). Deployment instructions 308 may then allow deployment server 330 to perform the actual deployment specified in the configuration document and the manifest. In other embodiments, the deployment server may call into the deployer in order to have the deployer perform the actual deployment of computing resources. As described herein, deployment compiler 320 may compile the configuration document 202 and the manifest 204, as well as the generated configuration information 306, in order to generate the set of one or more deployment instructions 308.

FIG. 5 illustrates a flow chart of an example method 500 of the above described deployment of computing resources from the perspective of the deployer. Method 500 will also be described with respect to the components of computer system 300. The method begins when the deployer has obtained both the set of one or more environment-independent directives identifying what to deploy contained within configuration document 202 (act 510), as well as the one or more manifests that include data regarding one or more environment-specific deployments that are generally non-mutually configurable with the other environment-specific deployments (act 520).

Based on the set of one or more environment-independent directives included within the configuration document and the environment-specific information included within the one or more manifests, the deployer then generates dynamic configuration information 306 (act 530). As described herein, the generated dynamic configuration information is then to be used by the deployment compiler 320 for generating a set of one or more deployment instructions 308, which are structured to be interpretable by the deployment server 330. The deployment server may then deploy the computing resources specified in the configuration document within the environment(s) specified in the manifest or may call into the deployer in order to have the deployer perform the actual deployment of resources.

Once again, the deployer may simply generate dynamic configuration information that includes providing occurrences of software installation dependencies associated with the set of one or more environment-independent directives, account subscription information associated with a user, a pointer to created storage associated with the set of one or more environment-independent directives, etc. However, the deployer may also perform deployment and pre-deployment tasks, such as ensuring that all software dependencies are available locally to any machine that is to be deployed, creating a VHD, creating storage, creating one or more virtual machines, or installing any desired operating systems, among other things.

In this way, a configuration document comprising instructions that are abstracted and independent from any particular environment in which computing resources are to be deployed (i.e., separate from the manifest that contains environment-specific data, as discussed herein) can be used repeatedly across different environments and applications when those same computing resources directed to be deployed within the particular configuration document are needed.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A computer system comprising:
one or more hardware processors;
one or more hardware storage devices having stored thereon computer-executable instructions that are executable by the one or more processors to configure the computer system to deploy computing resources in one or more non-mutually configurable environments by instantiating and/or operating the following:
a deployer that has access to one or more manifests, each manifest associated with one or more environment-specific deployments, each environment-specific deployment being non-mutually configurable with other environment-specific deployments, the deployer configured to use a set of one or more environment-independent directives and the one or more manifests to generate dynamic configuration information corresponding to the set of one or more environment-independent directives and the one or more manifests; and
a deployment compiler configured to compile at least the generated dynamic configuration information to thereby generate a set of one or more deployment instructions that are provided to, and structured to be interpretable by, a deployment server configured to assist in performing the set of one or more environment-independent directives within one or more of the non-mutually configurable environments.

2. The computer system of claim 1, wherein the deployment compiler is further configured to compile the set of one or more environment-independent directives and the one or more manifests to thereby generate the set of one or more deployment instructions.

3. The computer system of claim 1, wherein the generated dynamic configuration information comprises current software installation dependencies associated with the set of one or more environment-independent directives.

4. The computer system of claim 1, wherein the set of one or more environment-independent directives are obtained from one or more files separate from the one or more manifests.

5. The computer system of claim 1, wherein the set of one or more environment-independent directives include instructions to deploy a plurality of computing resources.

6. The computer system of claim 5, wherein according to the instructions and the one or more manifests, one of the plurality of computing resources is to be deployed in a first environment, and another of the plurality of computing resources is to be deployed in a second environment that is non-mutually configurable with the first environment.

7. The computing system of claim 1, wherein a separate deployment instructions file is generated for each environment-specified in the one or more manifests.

8. A method, implemented at a computer system that includes one or more processors, for computing resource deployment in one or more non-mutually configurable environments, the method comprising:
obtaining dynamic configuration information generated by a deployer, the deployer generating the dynamic configuration information based on a set of one or more environment-independent directives that identify what to deploy and one or more manifests, each manifest being associated with one or more environment-specific deployments, each environment-specific deployment being non-mutually configurable with other environment-specific deployments; and
compiling at least the dynamic configuration information to thereby generate a set of one or more deployment instructions structured to be interpretable by a deployment server.

9. The method of claim 8, further comprising compiling the set of one or more environment-independent directives and the one or more manifests to thereby generate the set of one or more deployment instructions.

10. The method of claim 8, wherein the generated dynamic configuration information comprises account subscription information associated with a user.

11. The method of claim 8, wherein the one or more manifests are obtained in one or more files separate from the set of one or more environment-independent directives.

12. The method of claim 8, wherein the set of one or more environment-independent directives include instructions to deploy a plurality of computing resources.

13. The method of claim 12, wherein according to the instructions and the one or more manifests, one of the plurality of computing resources is to be deployed in a first environment, and another of the plurality of computing resources is to be deployed in a second environment that is non-mutually configurable with the first environment.

14. The method of claim 8, wherein a separate deployment instructions file is generated for each environment-specified in the one or more manifests.

15. A method, implemented at a computer system that includes one or more processors, for computing resource deployment in one or more non-mutually configurable environments, the method comprising:
obtaining a set of one or more environment-independent directives identifying what to deploy;
obtaining one or more manifests, each manifest associated with one or more environment-specific deployments, each environment-specific deployment being non-mutually configurable with other environment-specific deployments;
generating dynamic configuration information based on the set of one or more environment-independent directives and the one or more manifests, the dynamic configuration information to be used by a deployment compiler for generating a set of one or more deployment instructions structured to be interpretable by a deployment server.

16. The method of claim 15, wherein the set of one or more environment-independent directives are configured to be reused in other applications.

17. The method of claim 15, wherein the generated dynamic configuration information comprises a pointer to created storage associated with the set of one or more environment-independent directives.

18. The method of claim 15, wherein the one or more manifests are obtained in one or more files separate from the set of one or more environment-independent directives.

19. The method of claim 15, wherein the set of one or more environment-independent directives include instructions to deploy a plurality of computing resources.

20. The method of claim 19, wherein according to the instructions and the one or more manifests, one of the plurality of computing resources is to be deployed in a first environment, and another of the plurality of computing resources is to be deployed in a second environment that is non-mutually configurable with the first environment.
